(19) United States
(12) Patent Application Publication
(10) Pub. No.: US 2013/0225030 A1
(43) Pub. Date: Aug. 29, 2013

(54) METHOD FOR DISASSEMBLING PLASMA DISPLAY DEVICE

(71) Applicant: Panasonic Corporation, Osaka (JP)

(72) Inventor: Tetsuro Ozawa, Osaka (JP)

(21) Appl. No.: 13/847,145

(22) Filed: Mar. 19, 2013

Related U.S. Application Data
(63) Continuation of application No. PCT/JP2012/002669, filed on Apr. 18, 2012.

(30) Foreign Application Priority Data
Sep. 1, 2011 (JP) 2011-190300

(51) Int. Cl. H01J 9/00

(52) U.S. Cl. CPC H01J 9/00
USPC 445/23

(57) ABSTRACT

The present disclosure relates to a method for disassembling a plasma display device including PDP (11) having front plate (20) and rear plate (21), and metal support plate (14) bonded to rear plate (21) of PDP (1.1) with bonding member (1.6) interposed therebetween. The method includes removing front plate (20) constituting PDP (11) to expose a surface of rear plate (21), and then removing formed layers on rear plate (21), followed by irradiation with infrared rays from a rear plate (21) side, to heat bonding member (16) between rear plate (21) and metal support plate (14) so as to decrease bonding strength, and thereafter to separate rear plate (21) and metal support plate (14).

### TECHNICAL FIELD

The present disclosure relates to a method for disassembling a plasma display device

### BACKGROUND ART

In recent years, as image display devices appropriate for slimming and upsizing, plasma display devices using plasma display panels (hereinafter referred to as a PDP) have been mass-produced and rapidly diffused.

The PDP is mounted on a display section of the plasma display device. The PDP includes a front plate formed with a display electrode, a dielectric layer, a protective layer, and the like on a glass substrate, and a rear plate formed with an address electrode, a barrier rib, a phosphor layer, and the like on a glass substrate. The front plate and the rear plate are arranged as opposed to each other so as to form a minute discharge space between both substrates, and peripheral edges of both substrates are sealed by frit glass. A discharge space is filled with a discharge gas formed by mixing inert gases such as a neon gas (Ne) and a xenon (Xe) gas.

A metal support plate as a chassis member is pasted to the rear surface of the rear plate of the PDP with an adhesive joint member such as a thermally conductive sheet interposed therebetween. The metal support plate has a function as the chassis member as well as a function as a heat sink. The chassis member is used. to be attached. with a circuit board. for driving the PDP, and the heat sink is used to efficiently dissipate heat generated by the drive of the PDP. Further, the plasma display device is mounted with a front frame and a back cover for protecting the PDP and the circuit board.

Incidentally, with the rapid diffusion of plasma display devices in recent years, the number of used and waste plasma display devices is on the rapid increase. Moreover, with an increase in production amount of plasma display devices, the absolute number of defective PDP units in a manufacturing process is also on the increase. Accordingly, from viewpoints of environmental issues and resource savings, it is becoming important to develop and introduce a technique of disassembling the used and waste plasma display device or the defective PDP unit generated in the manufacturing process so as to recycle members or reproduce them as raw materials.

Disassembling the plasma display device into a recyclable form requires separation of the PDP, the metal support plate, and the circuit board. Thereat, a variety of methods for separating the PDP unit have hitherto been proposed. For example, there has been proposed a method for heating the surface of a PDP by a hot plate to decrease bonding strength of a bonding member bonding the PDP and the metal support plate, so as to peel the PDP and. the metal support plate from the bonding member (refer to PTL 1, for example).

For disassembling the plasma display device into a recyclable form, the plasma display device is collected to a disassembly plant. However, the number of disassembly plants for plasma display devices has hardly been changed with respect to the increase in number of disassembly processing on plasma display devices, and hence the number of disassembly processing per plant is on the increase. There has thus been a challenge to increase disassembly processing ability of the disassembly plant.

Citation List

Patent Literature

PTL1.: Unexamined Japanese Patent Publication. No, 2005-116346

### SUMMARY

The present disclosure relates to a method for disassembling a plasma display device including a plasma display panel having a front plate and a rear plate, and a metal support plate bonded to the rear plate of the plasma display panel with a bonding member interposed therebetween. The method includes removing the front plate constituting the plasma display panel to expose a surface of the rear plate, then removing formed layers on the rear plate, followed by irradiation with infrared rays from the rear plate side, to heat the bonding member between the rear plate and the metal support plate so as to decrease bonding strength, and thereafter to separate the rear plate and the metal support plate.

### BRIEF DESCRIPTION OF DRAWINGS

FIG. 1 is an exploded perspective view of a plasma display device in an embodiment of the present disclosure.

FIG. 2 is a sectional view of a PDP unit in the embodiment of the present disclosure.

FIG. 3 is a flowchart explaining disassembly of the plasma display device in the embodiment of the present disclosure.

FIG. 4 is a sectional view showing a status of use of a disassembly device in the embodiment of the present disclosure.

### DESCRIPTION OF EMBODIMENT

Hereinafter, an embodiment of the present disclosure will be described with reference to the drawings.

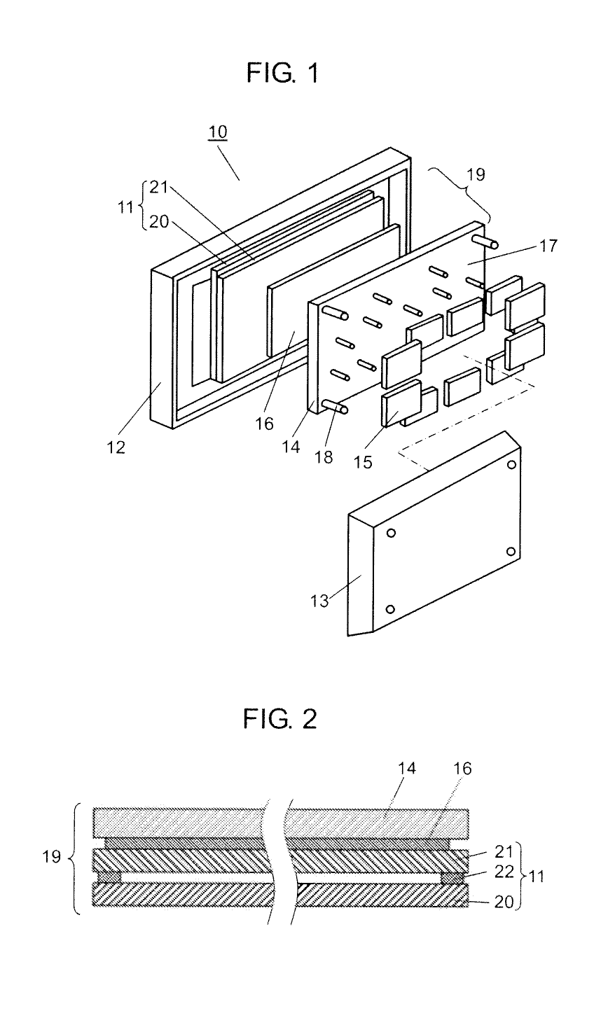

FIG. 1 is an exploded perspective view of a plasma display device in an embodiment of the present disclosure, and FIG. 2 is a sectional view of a PDP unit in the present disclosure.

In FIG. 1, plasma display device 10 is provided with PDP 11 and a housing where this PDP 11 is housed. The housing is configured in combination of front frame 12 and back cover 13. Between front frame 12 and back cover 13, metal support plate 14, circuit board 15, and bonding member 16 are arranged. Metal support plate 14 includes a metal plate made of aluminum or the like as a material, and also serves as a heat sink. Circuit board 15 is attached to metal support plate 14, and has a drive circuit for driving PDP 11. Bonding member 16 is a thermally conductive bonding sheet, and arranged between PDP 11 and metal support. plate 14 to bond PDP 11 and metal support plate 14, while conducting heat generated from PDP 11 to metal support plate 14. Further, metal support plate 14 is provided, with attachment 18 such as a fixing pin on attached surface 17 opposed to back cover 13. Back cover 13 and circuit board 15 are fixed by means of this attachment 18. As thus described, plasma display device 10 is arranged with PDP unit 19 including PDP 11 and metal support plate 14 which are bonded with bonding member 16 interposed therebetween. Next, a detailed structure of PDP unit 19 will be described with reference to FIG. 2. PDP unit 19 has PDP 11 and metal support plate 14 which are bonded with bonding member 16 interposed therebetween. PDP 11 includes front plate 20 and rear plate 21 which are made of glass with a thickness of 1.6 mm to 2.8 mm, and peripheral edges thereof are joined by sealing member 22 such as frit glass. Bonding member 16 is a thermally conductive bonding sheet applied with a bonding agent on both surfaces thereof. Bonding member 16 is arranged almost over rear plate 21. and metal support plate 14, and bonded with rear plate 21 and. metal support plate 14. Bonding member 16 transfers heat, generated at the time of driving PDP 11, to metal support plate 14 and suppresses temperature rises of front plate 20 and rear plate 21 at the time of driving PDP 11. This can reduce thermal expansion of front plate 20 and rear plate 21 due to the temperature rise, so as to prevent cracking and image deterioration of PDP 11.

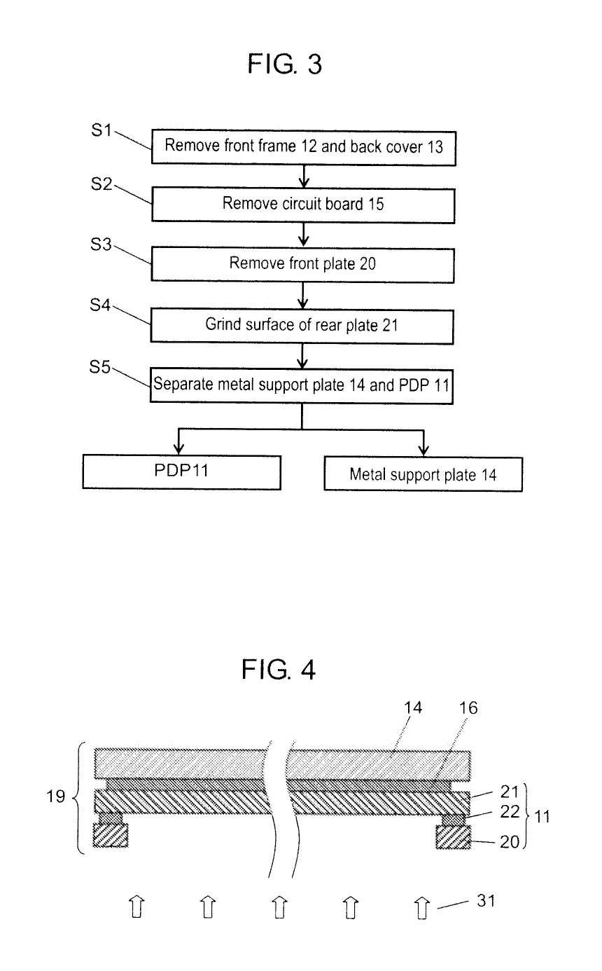

Next, a method for disassembling plasma display device 10 will he described with reference to FIGS. 3 and 4.

As shown in FIG. 3, first, front frame 12 and back cover 13 are removed from plasma display device 10 (S1).

Next, circuit board 15 is removed from metal support plate 14 of PDP unit 19 (S2).

Next, front plate 20 constituting PDP 11 is cut off and removed while leaving its peripheral edge where sealing member 22 is present (S3). As for cracked front plate 20, front plate 20 is broken into small pieces of glass by use of a plastic hammer or the like so as to be removed while leaving its peripheral edge.

The inner surface of rear plate 21 is exposed by removal of front plate 20, and thereafter, formed layers being an address electrode, a barrier rib, and a phosphor layer formed on rear plate 21 are peeled using a physical technique such as grinding (S4).

Next, after removal of the formed layers on rear plate 21, irradiation is performed with infrared rays 31 from the rear plate 21 side, to heat bonding member 16 between rear plate 21 and metal support plate 14. This heating leads to a decrease in bonding strength, then to separate rear plate 21 and metal support plate 14 (S5).

It is to be noted that, as for front plate 20 crushed and removed. in (S3), formed layers being a display electrode, a dielectric layer, and a protective layer formed on its surface are removed, and by such means as dissolution treatment, front plate 20 is recycled as glass material. Further, as for a glass substrate constituting rear plate 21 separated in (S5), after constituents left on its peripheral edge are removed, the glass substrate underwent dissolution treatment or the like, to be recycled as a glass material.

FIG. 4 is a schematic view explaining the process of separating PDP 11 and metal support plate 14 (S5). As shown in FIG. 4, front plate 20 is removed while leaving its peripheral edge where sealing member 22 is present, and thereafter, irradiation is performed with infrared rays 31 from the side where front plate 20 was present. Energy of infrared rays 31 is transmitted through rear plate 21 whose glass surface has been exposed, and absorbed in bonding member 16 in close contact with rear plate 21, to heat bonding member 16. Since the energy of infrared rays 31, with which irradiation was performed, does not attenuate along its path, it directly reaches bonding member 16. Accordingly, when bonding member 16 is rapidly heated to a temperature at which its bonding strength decreases, for example to a temperature of about 200° C., the bonding strength of bonding member 16 decreases, thereby allowing peeling of PDP 11 and metal support plate 14 in a short time.

Herein, for confirming the effect of heating by infrared rays 31, as for PDP 11 on which the processing up to the process of (S4) had been completed, the time until the temperature of bonding member 16 reached 200° C. was measured in the case of heating by infrared rays 31 and in the case of heating by an oven. For heating, infrared rays 31 with a peak wavelength of 1.2 μm and an output of 3.5 W/cm² were used. Further, PDP 11 was set inside the oven in a state where a temperature had previously been stabilized at 250° C. As a result, 200° C. were reached in three minutes after energization in the case of infrared heating, whereas 21 minutes were required in the case of the oven.

Subsequently, for confirming the range of an effective peak wavelength in infrared heating, a peak wavelength of infrared rays 31 used for heating is changed., to measure the time until the temperature of bonding member 16 reached 200° C. Table 1 shows this result.

TABLE 1

| Infrared ray peak wavelength | Time until 200° C. were reached |
|---|---|
| 1.2 μm | 3 min. |
| 2.6 μm | 4.5 min. |
| 4.5 μm | 7 min. |

As shown in Table 1, the longer the peak wavelength of infrared rays 31 becomes, the longer the time until 200° C. are reached tends to become, but it is short enough as compared with the case of the oven. Further, the longer the wavelength becomes, the weaker the energy generally becomes, but even in the case of far infrared rays with a peak wavelength of 4.5 μm in an infrared ray region, it remains the same that heating is performed by radiation, and a similar effect was recognized. In addition, the range of the peak wavelength of infrared rays 31 that is used is desirably from 1 μm to 5 μm.

As thus described, according to the present. embodiment, front plate 20 constituting the plasma display panel is removed while leaving its peripheral edge, followed by removal of the address electrode, the barrier rib, and the phosphor layer formed. on rear plate 21 by means of a physical technique such as grinding, and then followed by irradiation of bonding member 16 with infrared rays 31 via ground rear plate 21, whereby it is possible to decrease the bonding strength of bonding member 16 in a short time, so as to facilitate separation of PDP 11 and metal support plate 14. Hence it is possible to efficiently disassemble used plasma display device 10 and defective plasma display device 10 generated in a manufacturing process step.

Further, since heating by infrared ray 31 performed by thermal radiation, irradiation with infrared rays 31 may be performed with an arbitrary distance held from PDP 11, and it is not necessary to perform irradiation with infrared rays 31 while they are brought into close contact with front plate 20 constituting PDP 11.

Moreover, to deal with upsizing of facilities, an area of infrared rays 31 may be increased by adding the number of infrared heaters for irradiation with infrared rays 31, thereby to facilitate upsizing of the device.

### INDUSTRIAL APPLICABILITY

The present disclosure is useful in efficiently disassembling a used plasma display device and a defective plasma display device generated in a manufacturing process step.

### REFERENCE MARKS IN THE DRAWINGS

10 plasma display device

11 PDP

12 front frame

13 back cover

14 metal support plate

15 circuit board

16 bonding member

19 PDP unit

20 front plate

21 rear plate

22 sealing member

31 infrared rays

1. A method for disassembling a plasma display device, the plasma display device including:
a plasma display panel having a front plate and a rear plate; and
a metal support plate bonded to the rear plate of the plasma display panel with a bon ding member interposed therebetween, the method comprising:
removing the front plate constituting the plasma display panel to expose a surface of the rear plate;
then removing formed layers on the rear plate, followed by irradiation with infrared rays from a rear plate side, to heat the bonding member between the rear plate and the metal support plate so as to decrease bonding strength; and thereafter to separate the rear plate and the metal support plate.

2. The method for disassembling a plasma display device according to claim 1, wherein a peak wavelength of infrared rays is from 1 μm to 5 μm.
